(19) United States
(12) Patent Application Publication
(10) Pub. No.: US 2011/0299040 A1
(43) Pub. Date: Dec. 8, 2011

(54) AIR FILTER DEVICE AND VIDEO PROJECTOR USING AIR FILTER DEVICE

(75) Inventors: Yosuke Nishihata, Hirakata-shi (JP); Akira Miyanaga, Daito-shi (JP); Yoshiharu Arioka, Osaka-shi (JP)

(73) Assignee: SANYO ELECTRIC CO., LTD., OSAKA (JP)

(21) Appl. No.: 13/153,719

(22) Filed: Jun. 6, 2011

(30) Foreign Application Priority Data
Jun. 8, 2010 (JP) 2010-131291

(51) Int. Cl. G03B 21/16; B01D 46/42

(52) U.S. Cl. 353/52; 55/289

(57) ABSTRACT

An air filter device including a first air filter that captures dust from intake air and includes a rim, a filtering surface surrounded by the rim, and a grid dividing the filtering surface into a plurality of sections. A base includes an opening, through which air is drawn, and a frame, which surrounds the opening. The first air filter is coupled to the frame at an upstream side of the opening. A cleaner includes a rotation brush that moves along an upstream surface of the first air filter while rotating to remove dust from the first air filter. A support contacts and supports the rim and the frame at a downstream side of the first air filter against pressing forced applied to the first air filter by the rotation brush.

### CROSS-REFERENCE TO RELATED APPLICATIONS

This application is based upon and claims the benefit of priority from prior Japanese Patent Application No. 2010-131291, filed on Jun. 8, 2010, the entire contents of which are incorporated herein by reference.

### BACKGROUND OF THE INVENTION

The present invention relates to an air filter device and a video projector that uses the air filter device, and more particularly, to a structure that couples an air filter to an air filter device, which includes an automatic cleaner.

A video projector typically cools optical elements such as a light source lamp and light valves with cooling air. The cooling air may be ambient air that is drawn into the video projector through an air inlet formed in an outer case of the video projector. Dust, which is suspended in the cooling air, may collect on optical elements such as liquid crystal panels and lower the quality of a projected image. Thus, an air filter is arranged in the air inlet to capture the dust that is suspended in the air.

When used for a long period of time, the air filter may clog. Clogging of the air filter increases the intake resistance at the air inlet and reduces the amount of cooling air delivered to the optical elements. This results in insufficient cooling of the optical elements, such as the light source lamp and liquid crystal panels. It is thus preferable that the air filter be frequently cleaned. However, a video projector may be used in various positions. Thus, depending on where and how the video projector is oriented, it may be difficult to manually clean the air filter. To cope with this problem, an air filter cleaning device that automatically cleans the air filter has been developed to reduce maintenance work, such as the replacement and cleaning of the air filter.

Japanese Laid-Open Patent Publication No. 2008-65021 (hereinafter referred to as the '021 publication) describes a prior art example of an air filter device for a video projector. The video projector includes an air inlet for ambient air. A filter unit is coupled in a removable manner to the air inlet. The filter unit automatically cleans a pre-filter. The filter unit includes the pre-filter, a mechanical drive unit, brushes, and a secondary air filter. The pre-filer is moved in a fixed direction along an air intake plane during cleaning. The mechanical drive unit moves the pre-filter. The brushes sandwich the pre-filter from the downstream and upstream sides to remove dust from the pre-filter. The second air filter captures small particles of dust. In the filter unit, the brushes, of which longitudinal direction is perpendicular to the movement direction of the pre-filter, sandwich opposite sides of the air filter at the middle of the movement region of the pre-filter.

An air filter device, which automatically removes dust from an air filter, has also been developed for air conditioners. When an air filter is used over a long period of time in an air conditioner, the air filter clogs. This increases the air intake resistance and adversely affects the air conditioning capacity. Thus, the air filter of an air conditioner should also be frequently cleaned. Since manual cleaning of the air filter is burdensome, automated cleaning of the air filter has also been developed for air conditioners. Japanese Laid-Open Patent Publication No. 2009-82837 (hereinafter referred to as the '837 publication) describes a prior art example of an air filter device for an air conditioner.

The air filter device of the '837 publication is provided with a dust removal means, which includes a rotation brush (rotary cleaner), a dust box, and a motor. The rotation brush removes dust from an air filter. The dust box collects the dust removed by the rotation brush. The dust removal means vertically along an upstream surface of the air filter to remove dust from the air filter with the rotation brush.

In the air filter device of the '021 publication, the pre-filter is moved in contact with the brushes and through the brushes, which are fixed to the central part of the filter unit. Thus, a large space is used to accommodate the pre-filter.

In the air filter device of the '837 publication, the dust removal means, which includes the rotation brush, the dust box, and the motor, moves vertically along the upstream surface of the air filter. The air filter is not moved like in the '021 publication. Thus, the air filter may be accommodated in a smaller space than the '021 publication.

However, in the air-conditioner of the '837 publication, the rotation brush is rotated in a state forced against the surface of the air filter to remove dust from the air filter. This may deform the air filter in a direction in which the force applied by the rotation brush acts. When the air filter deforms, the rotation brush cannot apply sufficient force to the air filter. This lowers the dust removal capacity of the rotation brush. Further, deformation is greater at a central portion of the air filter than the peripheral portion. Thus, the dust removal capacity varies between the central portion and peripheral portion of the air filter. Accordingly, when the dust removal means applies force from the rotation brush to the air filter surface like in the '837 publication, the rigidity of the air filter must be increased.

### SUMMARY OF THE INVENTION

One aspect of the present invention is an air filter device including a first air filter, a base, a cleaner, and a support. The first air filter captures dust from intake air and includes a rim, a filtering surface surrounded by the rim, and a grid dividing the filtering surface into a plurality of sections. The base includes an opening, through which air is drawn, and a frame, which surrounds the opening. The first air filter is coupled to the frame at an upstream side of the opening. The cleaner is coupled to the base to move along and clean an upstream surface of the first air filter. The cleaner includes a rotation brush that moves along the upstream surface of the first air filter while rotating to remove dust from the first air filter. The support contacts and supports the rim and the grid at a downstream side of the first air filter against pressing forced applied to the first air filter by the rotation brush.

A further aspect of the present invention is a video projector including an optical system and an air filter device arranged in an air inlet through which air is drawn to cool the optical system. The air filter device includes a first air filter, a base, a cleaner, and a support. The first air filter captures dust from the drawn in air and includes a rim, a filtering surface surrounded by the rim, and a grid dividing the filtering surface into a plurality of sections. The base includes an opening, through which air is drawn, and a frame, which surrounds the opening. The first air filter is coupled to the frame at an upstream side of the opening. The cleaner is coupled to the base to move along and clean an upstream surface of the first air filter. The cleaner includes a rotation brush that moves along the upstream surface of the first air filter while rotating to remove dust from the first air filter. The support contacts and supports the rim and the frame at a downstream side of the first air filter against pressing forced applied to the first air filter by the rotation brush.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a video projector that uses an air filter device according to a first embodiment of the present invention;

FIG. 2 is a schematic plan view showing an optical system in the video projector of FIG. 1;

FIG. 3 is a side view showing the video projector of FIG. 1;

FIG. 4A is a side view showing the video projector oriented in an upward projection state;

FIG. 4B is a side view showing the video projector in a ceiling-suspended projection state;

FIG. 4C is a side view showing the video projector in a downward projection state;

FIG. 5 is a perspective view showing the air filter device drawn out of the video projector of FIG. 1 and reversed upside down;

FIG. 6 is a plan view showing the air filter device of FIG. 5;

FIG. 7 is an exploded perspective view showing the air filter device of FIG. 5;

FIG. 8 is a perspective view showing the air filter device in cross-section along line A-A in FIG. 1;

FIG. 9 is a perspective view showing the air filter device in cross-section along line B-B in FIG. 6;

FIG. 10 is a perspective view showing the air filter device in cross-section along line C-C in FIG. 6;

FIG. 11 is an enlarged view showing the interior of the automatic cleaner in the air filter device of FIG. 5;

FIG. 12 is a perspective view showing the automatic cleaner located at a return position;

FIG. 13 is a cross-sectional view of the air filter device taken along line D-D in FIG. 6;

FIG. 14 is a cross-sectional view of the air filter device taken along line E-E in FIG. 6;

FIG. 15 is a cross-sectional view showing the operation of the automatic cleaner;

FIG. 16 is a cross-sectional view showing the automatic cleaner returning to the standby position;

FIG. 17A is a cross-sectional view showing the state in which a first air filter is coupled in the first embodiment; and

FIG. 17B is a cross-sectional view showing the state in which a first air filter is coupled in a second embodiment.

### DETAILED DESCRIPTION OF THE INVENTION

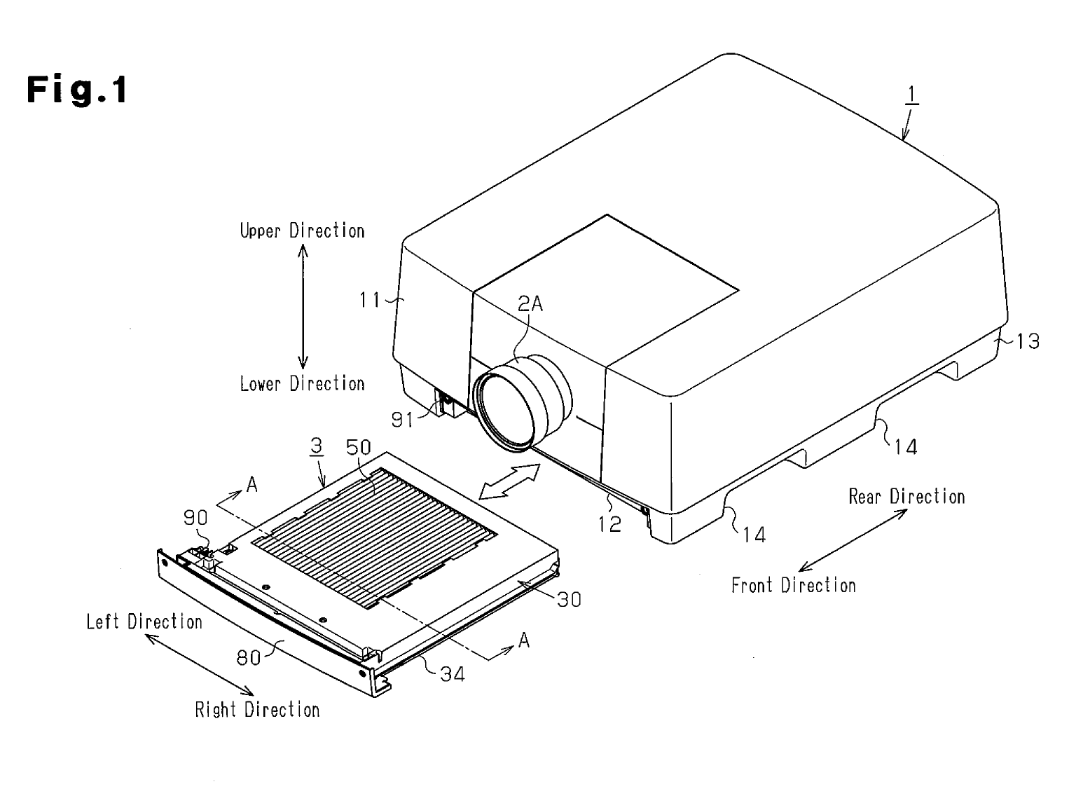

A video projector according to a first embodiment of the present invention will now be discussed with reference to the drawings. FIG. 1 shows a state in which the video projector is set upright. In the description hereafter, unless otherwise indicated, the upper, lower, left, right, front, and rear directions are as indicated by the arrows shown in FIG. 1.

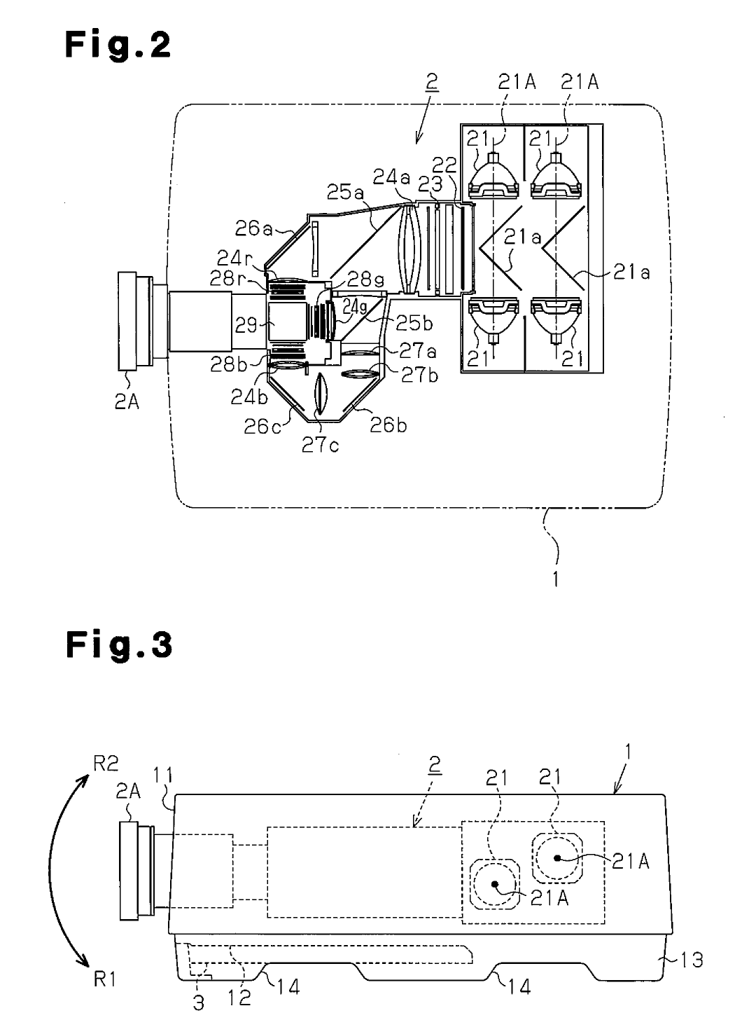

The video projector is, for example, a three-LCD type video projector. The projector includes an outer case 1 as shown in FIG. 1. The outer case 1 accommodates an optical system 2 such as that shown in FIG. 2. A projection lens 2A extends from a front wall 11 of the outer case 1. A filter unit 3, which serves as an air filter device, is arranged in an air inlet 12 of the outer case 1. The filter unit 3 can be slid out from the front wall 11 of the outer case 1. The filter unit 3 includes an upstream side that is in communication with the exterior of the projector through a plurality of slits 14, which are arranged in a side wall 13 of the outer case 1.

Referring to FIG. 2, the optical system 2 includes four light source lamps 21, which serve as a light source and are each formed by a discharge lamp. Each lamp 21 has an optical axis 21A, which is substantially parallel to the front wall 11 of the outer case 1. The illumination light generated by the four light source lamps 21 are combined by optical path changing members 21a and emitted in a predetermined direction (e.g., frontward direction).

An integrator lens 22, polarizing beam splitter 23, and condenser lens 24a guide the illumination light to a color separation optical system, which separates the illumination light into three colors of light, namely, red light, green light, and blue light. The color separation optical system includes, for example, two dichroic mirrors 25a and 25b, three total reflection mirrors 26a, 26b, and 26c, three relay lenses 27a, 27b, and 27c, and three condenser lenses 24r, 24g, and 24b. Red, green, and blue liquid crystal light valves 28r, 28g, and 28b respectively perform optical modulation on the red light, green light, and blue light. A cross-dichroic prism 29 combines the modulated light into image light, which is emitted from the projection lens 2A. Some of the elements in the optical system 2 require to be cooled with cooling air. The elements that are to be cooled are, for example, the lamps 21, the liquid crystal panels and polarization plates of the liquid crystal light valves 28r, 28g, and 28b, and the polarizing beam splitter 23. Of these, the lamps 21 become the hottest.

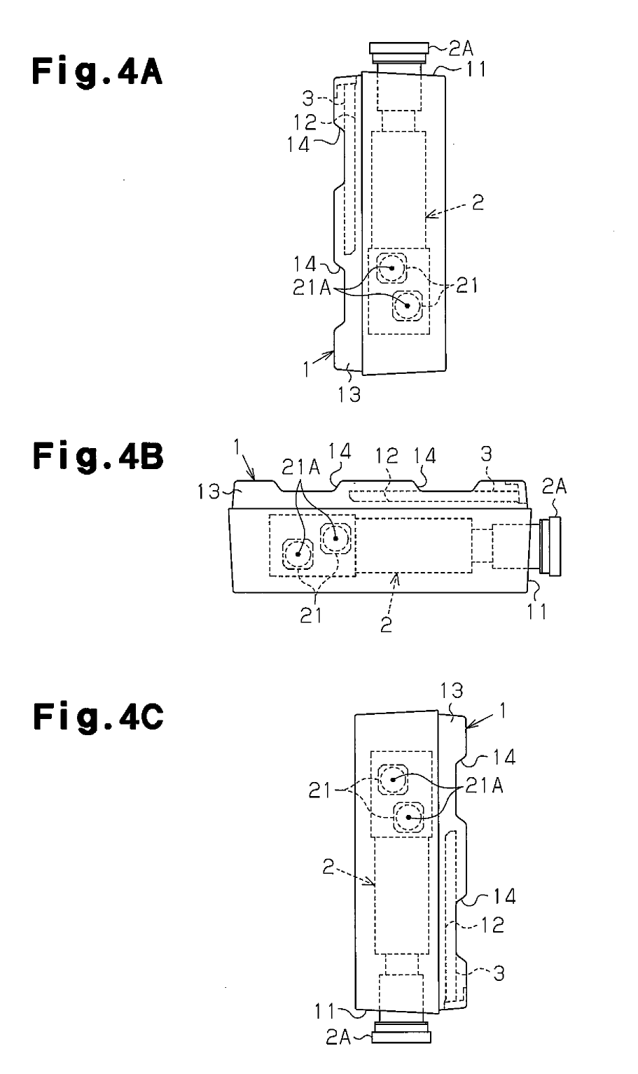

The video projector may be set in an upright projection state as shown in FIG. 3. The video projector may also be set in a state rotated from the state of FIG. 3 in the directions of arrows R1 and R2 so that the optical axis 21A of each lamp 21 is always horizontal. For example, the video projector may be set in an upward projection state shown in FIG. 4A, a suspended projection state shown in FIG. 4B, or a downward projection state shown in FIG. 4C. In this manner, the use of the video projector in a state in which the optical axis 21A of each lamp 21 is always horizontal prevents excessive heating of the lamps 21, which are formed by discharge lamps.

FIG. 1 shows the video projector in a state in which the filter unit 3 is drawn out from the front wall 11. FIGS.

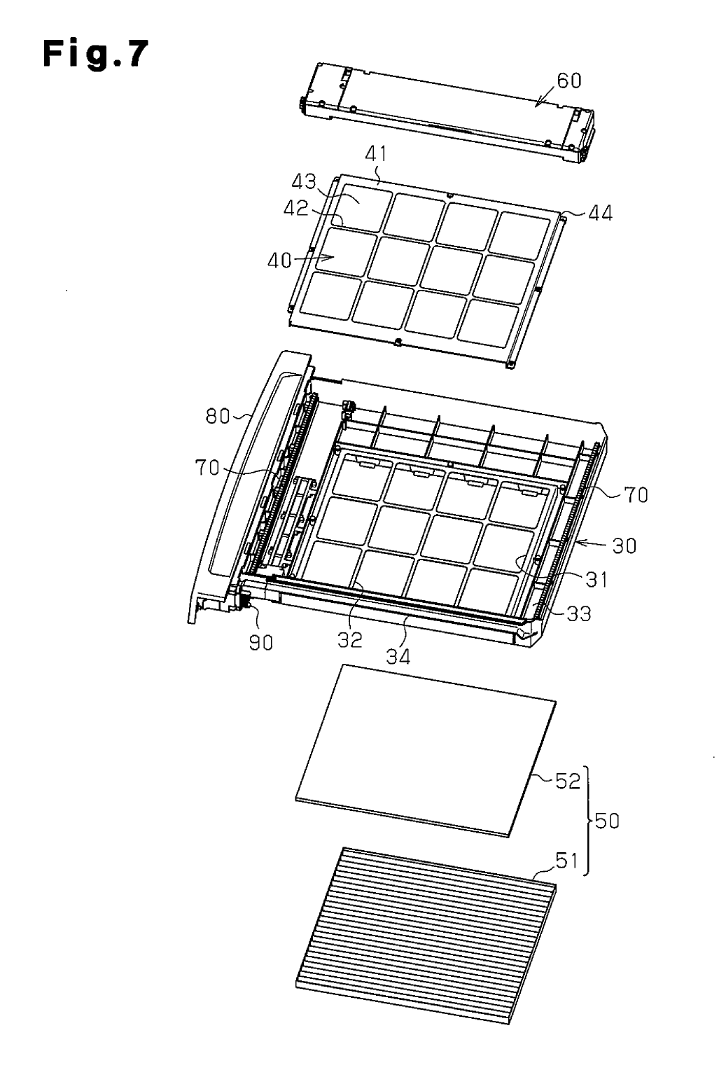

5 and 6 show the bottom surface of the filter unit 3, which is reversed upside down from the state of FIG. 1. Referring to the perspective exploded view of FIG. 7, the filter unit 3 includes a base 30, a first air filter 40, a second air filter 50, an automatic cleaner 60, two racks 70, and a handle 80. The first air filter 40 is arranged at an upstream side of the base 30. The second air filter 50 is arranged at the downstream side of the base 30. The handle 80 is arranged at the front of the base 30.

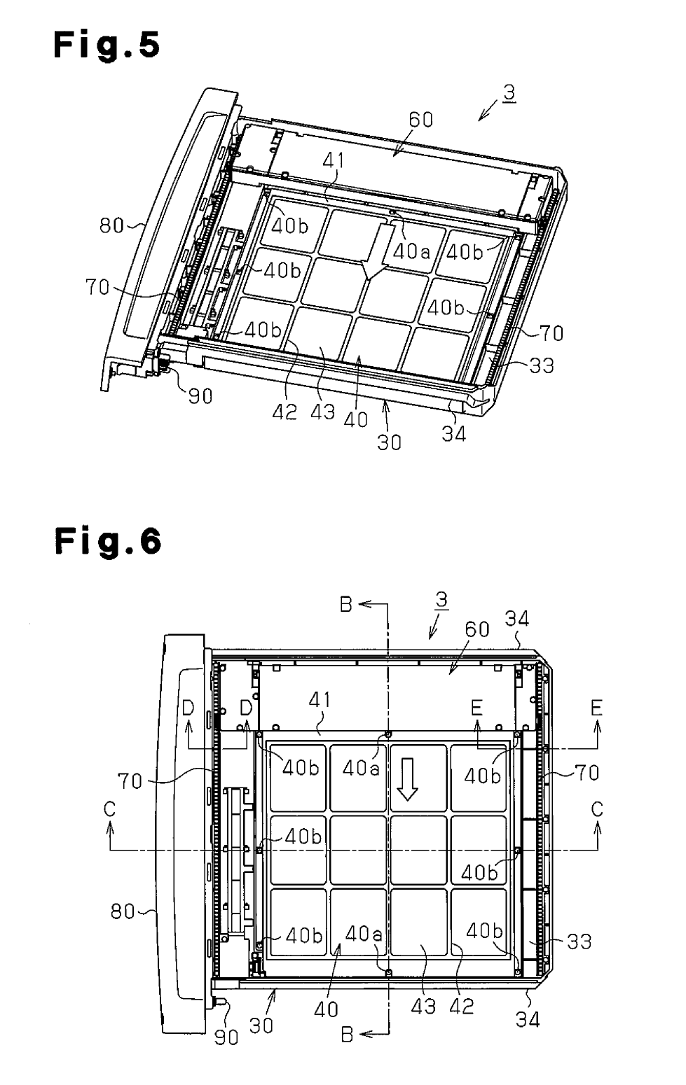

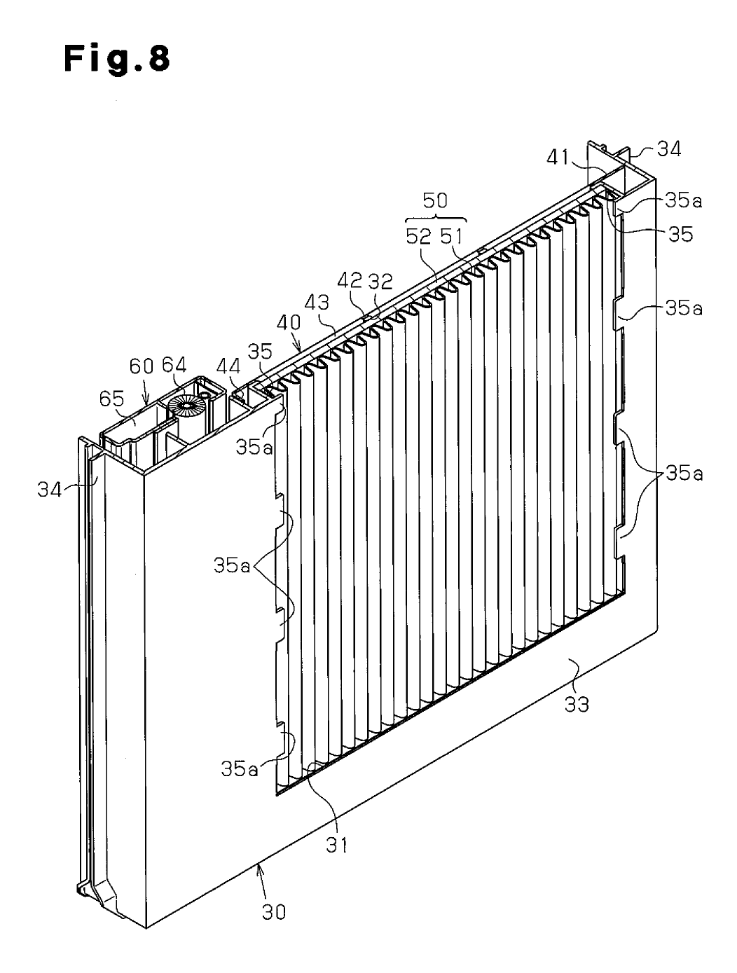

Referring to FIG. 7, the base 30, which is a molded resin product, includes an opening 31, a grid 32 (base grid), and a frame 33. Cooling air is drawn through the opening 31. The grid 32 extends over the opening 31. The opening 31 is surrounded by the frame 33. The grid 32 and the frame 33 have the same thickness (refer to FIG. 8). The handle 80 is coupled to the frame 33 of the base 30 near the front wall 11. The automatic cleaner 60 is coupled to the base 30 in a movable manner. As viewed from the front wall 11, when the filter unit 3 is located at the right side on the upstream surface of the base 30 as shown in FIG. 5, the automatic cleaner 60 is arranged at a standby position, which is the initial coupling position. The automatic cleaner 60 is in a non-cleaning state when located at the standby position. The base 30 has left and right walls each including a rail 34. The filter unit 3 slides along the rails 34 when coupled to the outer case 1. The two racks 70 are coupled to the upstream side of the base 30 as shown in FIG. 7. The racks 70 are located at opposite sides of the opening 31 on the upstream surface of the base 30. The racks 70 are used to move the automatic cleaner 60.

The first air filter 40 is coupled to the upstream side of the base 30 at a position corresponding to the opening 31.

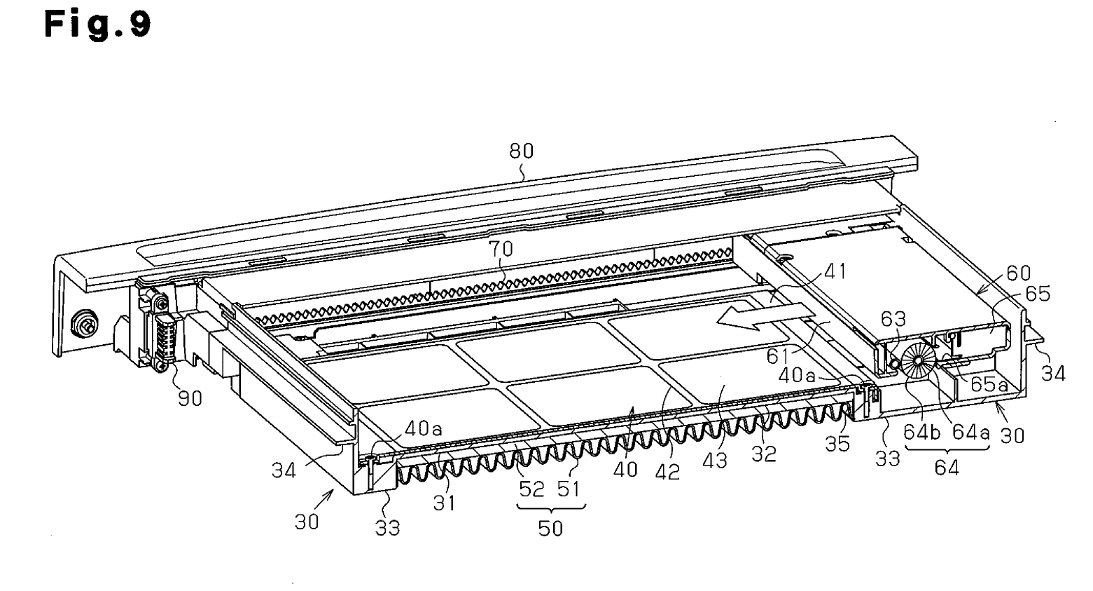

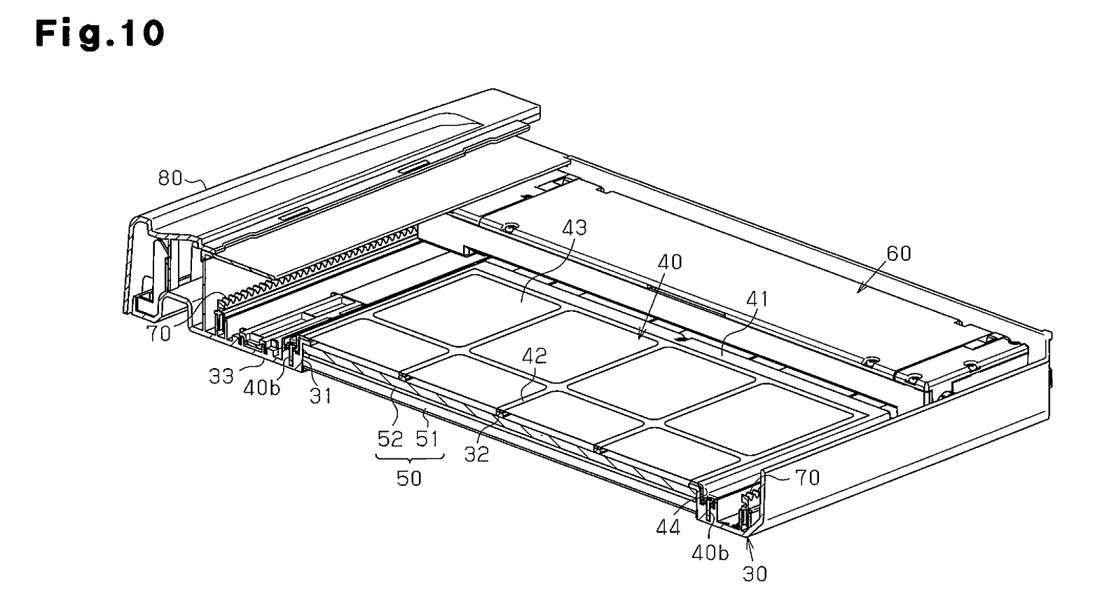

As shown in FIG. 7, the first air filter 40 includes a rim 41, a grid 42, and a porous filtering portion 43, which are molded integrally with one another from a resin material. The grid 42 divides a filtering surface formed at the inner side of the rim 41 into a plurality of sections. The porous filtering portion 43 captures dust from air. In the present embodiment, the rim 41 includes a bent portion 44 to increase rigidity and strength. When cleaning is performed, force is applied to the filtering surface. This deforms the first air filter 40 in the direction in which the force acts. To reduce the deformation, the inner shape and dimensions of the rim 41 are generally the same as those of the opening 31 in the base 30. Further, the shape and size of the grid 42 is generally the same as the grid 32 of the base 30. In addition, fasteners fasten the rim 41 of the first air filter 40 to the frame 33 of the base 30 in a direction generally orthogonal to the filtering surface. For example, as shown in FIG. 9, screws 40a fasten left and right parts of the first air filter 40 to upstream projections formed on the frame 33. As shown in FIG. 10, the screws 40b fasten front and rear parts of the first air filter 40 to the frame 33 at positions that are deeper than the upstream projections.

The second air filter 50 is coupled to the downstream side of the base 30 in correspondence with the opening 31 of the base 30.

As shown in FIG. 7, the second air filter 50 includes an electrostatic filtering member 51, which includes polymer fibers charged with static electricity, and a urethane sheet 52, which is flat and functions as a cushion. The urethane sheet 52 is located at the downstream side of the frame 33 of the base 30 and the upstream side of the electrostatic filtering member 51. As shown in FIG. 8, the frame 33 of the base 30 includes U-shaped grooves, or U-shaped retainers 35, which hold edges of the second air filter 50. The U-shaped retainers 35 include a plurality of holding portions, or tabs 35a, which extend inward from the frame 33 into the opening 31. Accordingly, the upstream side of second air filter 50, which is the urethane sheet 52, is supported in a state abut against the frame 33 of the base 30, and the edges of the urethane sheet 52 are forced into the U-shaped retainers 35. In this manner, the second air filter 50 is also coupled to the frame 33 of the base 30 in a direction generally orthogonal to the filtering surface. By coupling the second air filter 50 in this manner, deformation of the first air filter 40 is reduced when force is applied to the filtering surface of the first air filter 40 during cleaning. In other words, the grid 32 of the base 30 and the second air filter 50 cooperate to suppress deformation of the first air filter 40. Thus, the rigidity of the first air filter 40 is increased, and deformation of the first air filter 40 is suppressed.

As shown in FIG. 8, the electrostatic filtering member 51 of the second air filter 50 includes a filtering sheet, which has a plurality of pleats folded in the lateral direction. The electrostatic filtering member 51 captures particles of dust that are finer than the particles of dust captured by the first air filter 40. The urethane sheet 52, which functions as a cushion, facilitates the coupling of the edges of the second air filter 50 to the U-shaped retainers 35.

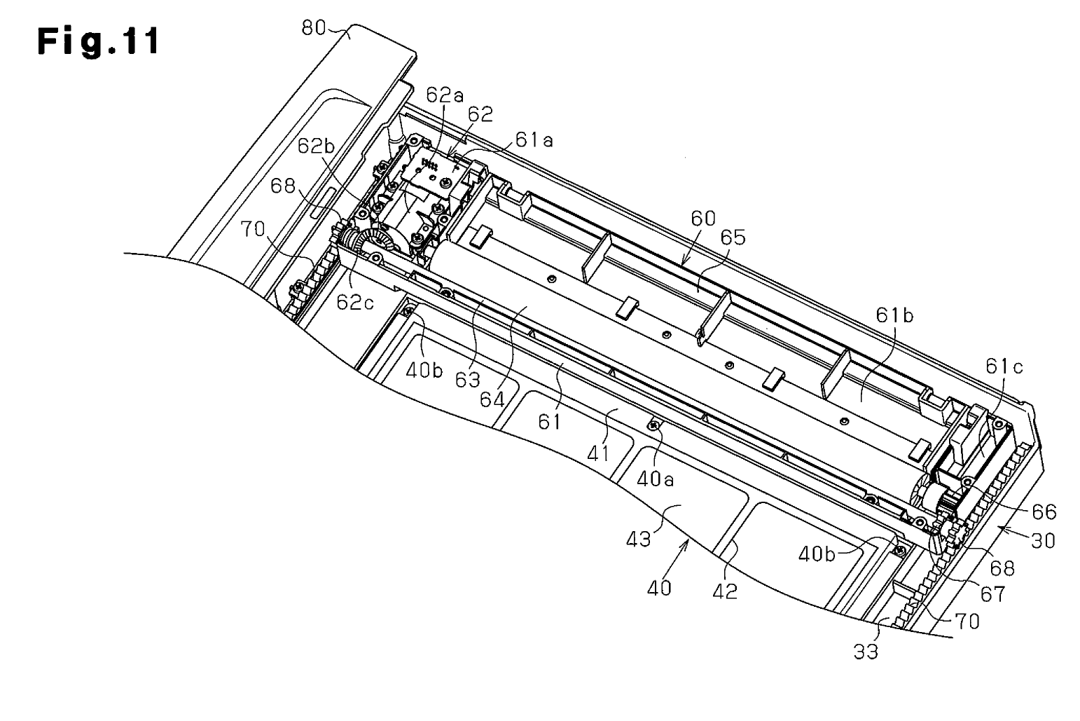

FIG. 9 shows the automatic cleaner 60 partially in cross-section. FIG. 11 shows the interior of the automatic cleaner 60. The automatic cleaner 60 is arranged at the upstream side of the filter unit 3 and includes a housing 61 elongated in a frontward direction of the first air filter 40. As shown in FIG. 11, the housing 61 is partitioned into a drive compartment 61a, which accommodates a drive unit 62, a dust removal compartment 61b, which accommodates a transmission shaft 63, a rotation brush 64, and a dust box 65, and a clutch compartment 61c, which accommodates a one-way clutch 66.

The drive unit 62 includes a motor 62a and bevel gears 62b and 62c. The motor 62a includes an output shaft, which extends perpendicular to the longitudinal direction of the housing 61. The bevel gear 62b is arranged on the output shaft of the motor 62a. The bevel gear 62c is arranged on the transmission shaft 63 in engagement with the bevel gear 62b. Torque is transmitted from the motor 62a to the transmission shaft 63.

The clutch compartment 61c accommodates a spur gear 67 and the one-way clutch 66. The spur gear 67 is arranged on a rear end of the transmission shaft 63. The one-way clutch 66 is arranged on a shaft 64a of the rotation brush 64. The transmission shaft 63 has two ends projecting outward from the housing 61. A pinion 68 is arranged on each end of the transmission shaft 63. Each pinion 68 is engaged with the corresponding rack 70.

The dust removal compartment 61b has a length that is about the same as that of the left and right sides of the first air filter 40. The transmission shaft 63, rotation brush 64, and dust box 65 are arranged in the dust removal compartment 61b in this order from the side closer to the first air filter 40. The lengths of the transmission shaft 63, rotation brush 64, and dust box 65 are about the same as the left and right sides of the first air filter 40.

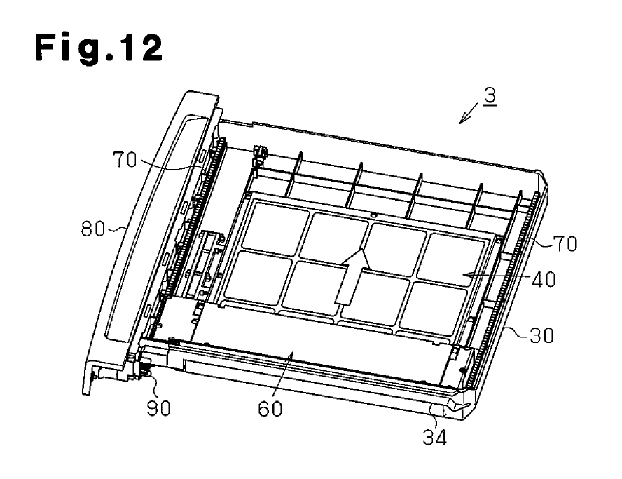

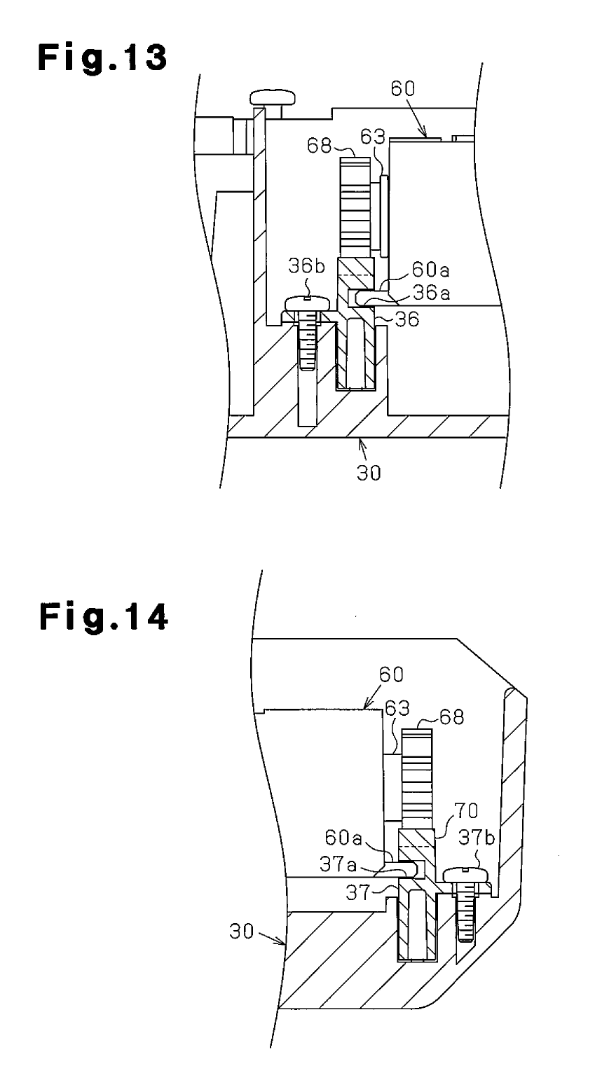

The motor 62a rotates the transmission shaft 63 through the engagement of the bevel gears 62b and 62c in the drive compartment 61a. The pinions 68 at the two ends of the transmission shaft 63 are engaged with the corresponding racks 70. The gear mechanism of the pinions 68 and racks 70 convert rotation of the transmission shaft 63 to linear motion of the automatic cleaner 60. Accordingly, the motor 62a drives the automatic cleaner 60 from the standby position shown in FIG. 5 to the opposite return position shown in FIG. 12. A sensor (not shown) detects the automatic cleaner 60 when moved to the return position. In response to such detection, the motor 62a produces reverse rotation and returns the automatic cleaner 60 to the standby position. In one example, the pinions 68 are rotated in the counterclockwise direction as viewed from the front wall 11 when the automatic cleaner 60 moves from the standby position of FIG. 5 to the return position of FIG. 12. The pinions 68 are rotated in the clockwise direction as viewed from the front wall 11 when the automatic cleaner 60 moves from the return position of FIG. 12 to the standby position of FIG. 5. As shown in FIGS. 13 and 14, planar projections 60a project from front and rear walls of the housing 61. Seats 36 and 37 respectively support the two racks 70 of the base 30. Grooves 36a and 37a are respectively formed on side walls of the seats 36 and 37 to receive the projections 60a in a movable manner. Screws 36b and 37b shown in FIGS. 13 and 14 fix the seats 36 and 37 to the base 30.

The rotation brush 64 includes a shaft 64a, which is formed from metal or resin, and a brushing member 64b, which is wound around the shaft 64a. The one-way clutch 66 is arranged on the rear end of the shaft 64a.

The rotation brush 64 extends upward from the dust removal compartment 61b toward the first air filter 40 to remove dust from the first air filter 40. The dust box 65 is formed at the rear of the rotation brush 64 with respect to the direction in which the automatic cleaner 60 moves from the standby position of FIG. 5 to the return position of FIG. 12. The rotation brush 64 and the dust box 65 are positioned to allow for a distal part of the rotation brush 64 to enter the dust box 65 from an inlet.

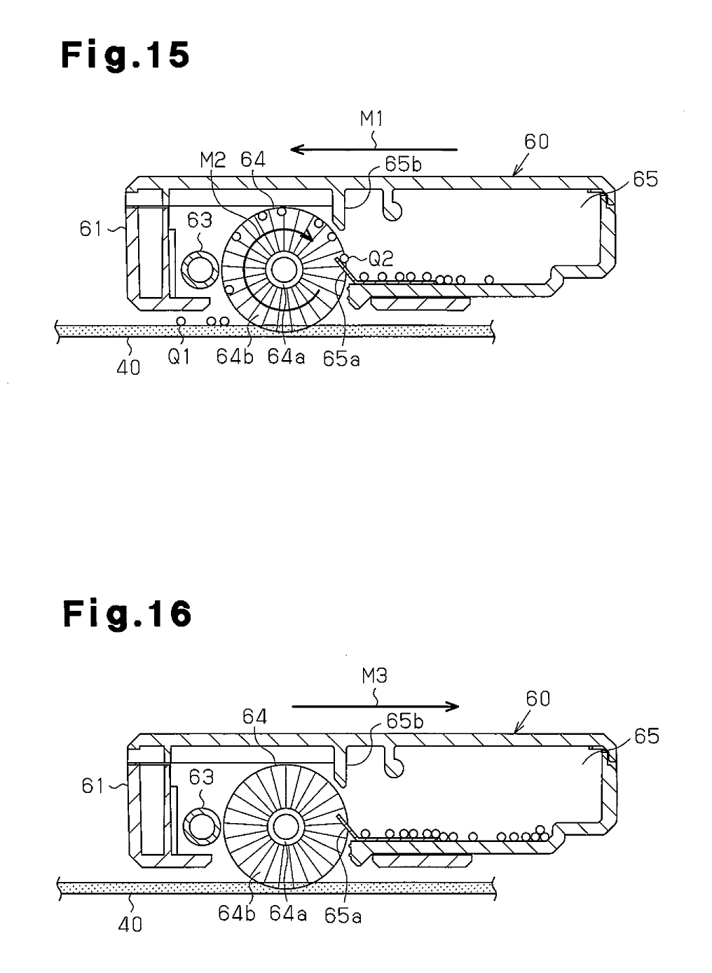

As shown in FIGS. 15 and 16, a comb-shaped dust remover 65a extends downward (upward as viewed in FIGS. 15 and 16), is arranged in the inlet of the dust box 65. A partition wall 65b extends from a lower part (upper part as viewed in FIGS. 15 and 16) of the inlet of the dust box 65 to partition the portion including the dust box 65 and rotation brush 64. The partition wall 65b prevents dust, which is removed from the rotation brush 64 by the dust remover 65a and collected in the dust box 65, from being scattered out of the dust box 65.

As shown in FIG. 1, the filter unit 3 includes a connector 90, which is arranged behind the handle 80 and beside the base 30. The connector 90 connects the filter unit 3 to a power supply and a control line. Further, the connector 90 is connected to a connector 91, which is arranged on the outer case 1 and connected to a power supply and a control line. Connection of the connector 90 of the filter unit 3 to the connector 91 of the outer case 1 supplies the filter unit 3 with power and operates the filter unit 3 based on commands from an operation unit or control unit of the video projector. When the filter unit 3 is slid into and coupled to the outer case 1, the connector 90 of the filter unit 3 becomes connected to the connector 91 of the outer case 1.

The operation of the filter unit 3 will now be discussed.

The filter unit 3 is slid into and coupled to the video projector from the front wall 11. This connects the connector 90, which is hidden at the rear side of the handle 80, to the connector 91 of the outer case 1. The filter unit 3 is controlled in correspondence with the operation of the video projector.

The filter unit 3 is operated when, for example, a filter sensor (not shown) detects clogging of the first air filter 40. Although not particularly limited, the filter sensor detects an increase in the current of fan motor (not shown) that corresponds to an increase in the intake resistance when the first air filter 40 clogs.

When operating the filter unit 3, the motor 62a is activated to rotate the transmission shaft 63 and the pinions 68. This moves the automatic cleaner 60 from the standby position shown in FIG. 5 to the return position shown in FIG. 11 (refer to arrow M1 in FIG. 15). During the movement, the rotation brush 64 rotates in the direction of arrow M2 in FIG. 15 while downwardly pressing the first air filter 40. This removes dust particles Q1 from the first air filter 40. The comb-shaped dust remover 65a at the inlet of the dust box 65 removes dust particles Q2 from the rotation brush 64. The dust particles Q2 are collected in the dust box 65.

When the rotation brush 64 removes the dust particles Q1 from the first air filter 40, the rotation brush 64 presses the filtering surface of the first air filter 40 toward the base 30. This may flex and deform the first air filter. If the first air filter 40 were to be deformed, the reaction force of the first air filter 40 produced against the pressing force of the rotation brush 64 would decrease. Further, the area of contact between the rotation brush 64 and the first air filter 40 would decrease. As a result, the rotation brush 64 cannot apply sufficient pressing force on the first air filter 40. This lowers the dust removal capability. When the deformation amount of the first air filter 40 becomes significantly large, the rotation brush 64 cannot press and contact the first air filter 40. As a result, dust particles Q1 cannot be removed from the first air filter 40. Since deformation of the first air filter 40 is greater at locations closer to the center, the pressing force varies between the peripheral portion and central portion of the first air filter 40. This may vary the dust removal capacity.

In the present embodiment, however, the inner shape and dimensions of the rim 41 are generally the same as the opening 31 in the base 30. Further, the shape and size of the grid 42 of the first air filter 40 is generally the same as the grid 32 in the opening 31 of the base 30. Thus, the frame 33 and grid 32 of the base 30 function to support the rim 41 and grid 42 of the first air filter 40. In other words, the base 30 functions as a support. Further, in the present embodiment, the second air filter 50 supports the frame 33 and grid 32 of the base 30. This suppresses deformation of the first air filter so that the dust removal capacity does not decrease or vary.

When a sensor (not shown) detects that the automatic cleaner 60 has reached the return position shown in FIG. 11, the motor 62a produces reverse rotation. This moves the automatic cleaner 60 to the standby position shown in FIG. 5 (refer to arrow M3 in FIG. 16). When the automatic cleaner 60 moves to the standby position, reverse rotation of the rotation brush 64 may scatter the dust particles Q2 collected in the air filter 40. Thus, in the present invention, the one-way clutch 66 is used to cut the transmission of torque from the motor 62a to the rotation brush 64.

The operation of the filter unit 3 described above is automatically repeated to clean the first air filter 40. Accordingly, the number of times required to clean and replace the first air filter 40 is significantly reduced in comparison to when manually cleaning the first air filter 40. However, the amount of dust on the first air filter 40 increases when the video projector is used over a long period of time. Thus, the first air filter 40 should be removed and cleaned or replaced with a new one after a certain period elapses. In the present embodiment, maintenance is performed on the first air filter 40 as described below.

First, the filter unit 3 is drawn out and removed from the front wall 11 of the video projector. This disconnects the connector 90 of the filter unit 3 and the connector 91 of the base 30 without the need for directly touching the connectors 90 and 91. Thus, connectors do not have to be manually removed from the filter unit 3.

Then, the drawn out filter unit 3 is reversed upside down as shown in FIG. 5. This state allows for the screws 40a and 40b to be unfastened from the filtering surface of the base 30 in a direction perpendicular to the filtering surface. Thus, the first air filter 40 may be easily removed from the base 30 so that the first air filter 40 can be properly washed or cleaned. When necessary, the first air filter 40 may be replaced by a new one. The first air filter 40, which is new or washed (cleaned), is set at a position corresponding to the opening 31 of the base 30 and fastened to the base 30 by the screws 40a and 40b.

To perform maintenance on the second air filter 50 such as washing, cleaning, and replacement, the second air filter 50 may easily be removed from the frame 33 of the base 30 in a direction perpendicular to the filtering surface. More specifically, the filter unit 3 is removed from the front wall 11 of the video projector. Then, the edges of the second air filter 50 are pulled out of the U-shaped retainers 35 to remove the second air filter 50 from the base 30. When the second air filter 50, which is new or washed (cleaned), is coupled to the base 30, the upstream side of the urethane sheet 52 is arranged in contact with and supported by the frame 33 of the base 30. Parts of the edges of the laminated body of the electrostatic filtering member 51 and the urethane sheet 52 are forced into the U-shaped retainers 35. This facilitates the coupling of the second air filter 50 to the base 30. In this manner, the second air filter 50 is easily coupled to and removed from the base 30.

The air filter device and video projector of the present embodiment have the advantages described below.

(1) The automatic cleaner 60 moves the rotation brush 64 along the filtering surface at the upstream side of the first air filter 40 from the standby position to the return position. This removes dust from the first air filter 40. Accordingly, the first air filter 40 does not have to be moved on the base 30 like in the prior art. This allows for the container that accommodates the first air filter 40 to be reduced in size.

(2) The rotation brush 64 moves along the upstream surface of the first air filter 40 while rotating and removing dust from the first air filter 40. This improves the efficiency for removing dust from the first air filter 40.

(3) The rim 41 and grid 42 of the first air filter 40 are arranged opposing the frame 33 and grid 32 of the base 30. This suppresses deformation of the first air filter 40, which, in turn, increases the reaction force of the first air filter 40 against the rotation brush 64 and obtains the intended cleaning capacity.

(4) The grid 32 of the base 30 has generally the same thickness as the frame 33 extending around the opening 31. In contrast with when the thickness of the grid 32 is greater than the thickness of the frame 33, this structure reduces deformation of the first air filter 40 without increasing the dimensions of the air filter device in the air flow direction.

(5) The grid 42 of the first air filter 40 and the grid 32 of the base 30 have generally the same shape and dimensions. Thus, the rigidity of the first air filter 40 may be efficiently increased with low material cost.

(6) In the first air filter 40, the rim 41, the grid 42, and the filtering portion 43 are molded integrally from a resin material. In comparison to when the filtering portion 43 is formed separately from and adhered to the rim 41 and grid 42, this structure increases the rigidity of the first air filter 40.

(7) The second air filter 50, which captures particles of dust that are finer than those captured by the first air filter 40, is arranged at the downstream side of the base 30. In this structure, the frame 33 and the grid 32 of the base 30 also function to support the second air filter 50. This simplifies the coupling of the second air filter 50. When the rotation brush 64 applies a pressing force against the filtering surface of the first air filter 40, the rigidity of the second air filter 40 increases the reaction force produced against the pressing force. This suppresses deformation of the first air filter.

(8) The frame 33 of the base 30 includes the U-shaped retainers 35, which hold the edges of the second air filter 50. Parts of the edges of the second air filter 50 are elastically inserting into and supported BY the U-shaped retainers 35. This facilitates the structure for coupling of the second air filter 50 to the base 30 while using the rigidity of the second air filter 50 to suppress deformation of the first air filter 40.

(9) The first air filter 40, the base 30, the rotation brush 64, and the motor 62a form a single unit that is coupled in a removable manner to the product to which it is applied. As a result, the first air filter 40 of the filter unit 3 has an increased cleaning capacity, and the range of products to which the filter unit 3 may be applied is increased.

(10) The video projector of the present embodiment includes the air inlet 12, which draws in air for cooling the optical system 2, in the air filter device (filter unit 3). This allows for reduction in the size of the entire video projector. Further, the automatic cleaner 60 automatically cleans the first air filter 40 and has a high dust removal capacity. This significantly increases the maintenance efficiency of the first air filter 40.

(11) The filter unit 3 of the present embodiment automatically cleans the first air filter 40 with the rotation brush 64 of the automatic cleaner 60. Further, the first air filter 40 does not move on the base like in the prior art. This allows for the first air filter 40 to be accommodated in a smaller space. Further, the rigidity of the base 30 together with the rigidity of the first air filter 40 provide resistance against a pressing forced applied to the first air filter 40 by the rotation brush 64. This suppresses deformation of the first air filter 40 and maintains the intended cleaning capacity. To increase the rigidity of the first air filter 40, the thickness of the grid 42 in the first air filter 40 may be increased. Further, ribs may be added to the grid 42 to improve strength. However, in such cases, the thickness of the grid 42 would be increased, which increases costs.

A video projector according to a second embodiment of the present invention will now be described.

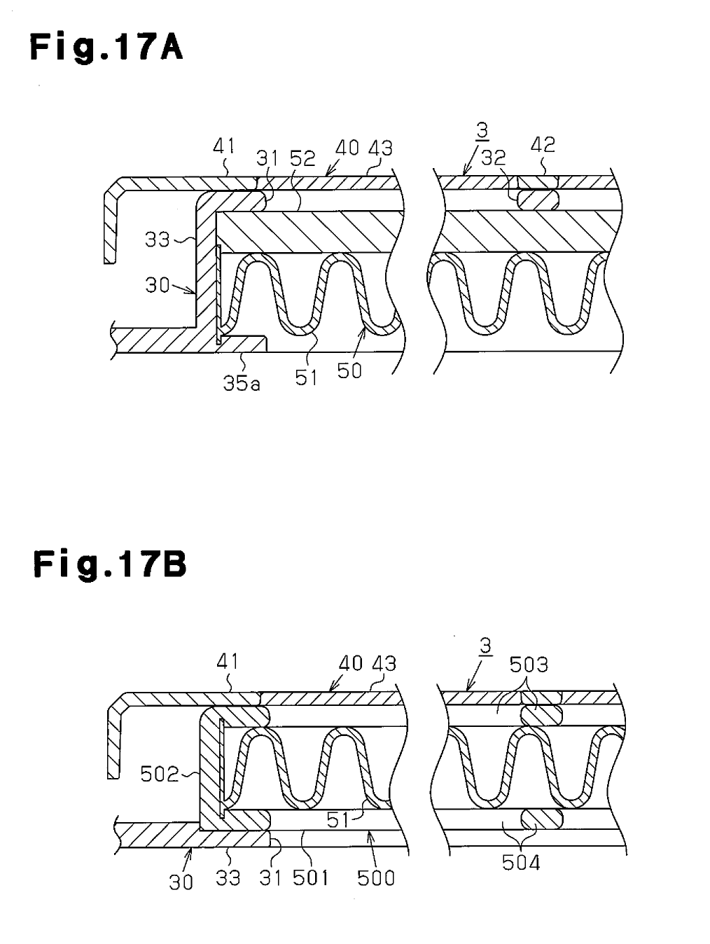

As shown in the enlarged cross-sectional view of FIG. 17A, the video projector of the first embodiment uses the base 30 as a support that supports the first air filter 40. More specifically, the base 30 supports the rim 41 and grid 42 of the first air filter 40 in a state in which the rim 41 and grid 42 are in contact with the frame 33 and grid 32 of the base 30. Further, the second air filter 50 is coupled to the surface of the first air filter 40 that is opposite to the base 30, namely, the downstream surface. Further, the second air filter 50 is formed by two members, namely, the electrostatic filtering member 51 and the urethane sheet 52. However, the present invention is not limited to such a structure and may be varied within the scope of the invention. A second embodiment of the present invention will now be described with reference to FIG. 17B centering on differences from the first embodiment. Like or same reference numerals are given to those components that are the same or similar in the first embodiment. Such components will not be described.

In the second embodiment, the first air filter 40 and a second air filter 500 are arranged on the same side of the base 30. Thus, the second air filter 500 is arranged on the downstream side of the base 30. The first air filter 40 is identical to that of the first embodiment. However, the second air filter 500 is modified to support the first air filter 40 with a frame 501. The frame 501 is formed by a rim 502, which has a U-shaped cross-section, and grids 503 and 504, which are formed on front and rear sides. The grids 503 and 504 are shaped identically the grid 42 of the first air filter 40. The frame 501 accommodates only the electrostatic filter 51. Although not shown in the drawings, the first air filter 40 and the second air filter 500 are fastened to the base 30 with fasteners such as screws.

In addition to advantages (1), (2), (9), and (10) of the first embodiment, the second embodiment has the following advantage.

(12) The rim 41 and grid 42 of the first air filter 40 is supported by the rim 502 and grids 503 and 504 of the second air filter 500. That is, in the second embodiment, the second air filter 500 functions as a support that supports the first air filter 40. Thus, the strength of the second air filter 500 is added to the strength of the first air filter 40. This suppresses deformation of the first air filter 40.

It should be apparent to those skilled in the art that the present invention may be embodied in many other specific forms without departing from the spirit or scope of the invention. Particularly, it should be understood that the present invention may be embodied in the following forms.

In each embodiment described above, the rim 41, the grid 42, and the porous filtering portion 43, which captures dust from the air, are molded integrally from resin to form the first air filter 40. However, there components may be formed separately and then be adhered to each other.

In each embodiment described above, the first air filter 40 is fastened by screws to the frame 33 extending around the opening 31. However, the first air filter 40 may be slid on and coupled to the frame 33 in any of frontward, rearward, leftward, and rightward directions.

In the first embodiment, the second air filter 50 is formed by two components, the electrostatic filter 51 and the urethane sheet 52. However, the urethane sheet 52 may be eliminated in the same manner as the second embodiment.

In each embodiment described above, the filter unit 3 may move only the rotation brush 64. In this case, the dust box 65 is fixed near the standby position. When the rotation brush 64 returns to the dust box 65, the dust box 65 removes dust from the rotation brush 64 and collects the removed dust. Further, the rotation brush 64 may be driven by two motors, one for movement and one for rotation. In this case, the rotation brush 64 may be rotated in a fixed direction regardless of the movement direction.

In the first embodiment, the U-shaped retainers 35, which hold the second air filter 50, are formed in parts of each side surrounding the opening 31 of the base 30. However, the U-shaped retainers 35 may be formed entirely on the sides parallel to the folding of each pleat.

In each of the embodiments described above, the filter unit 3 is operated when a sensor detects clogging of the first air filter 40. However, the filter unit 3 may be automatically operated whenever the video projector ends projection of an image. The filter unit 3 may also be periodically operated at a controlled timing or in response to operation of a cleaning switch.

In each of the embodiments described above, the optical system 2 is a three-LCD type including the transmission liquid crystal light valves 28r, 28g, and 28b. However, the video projector may use an optical system of a single-LCD type, for example.

In each of the embodiments described above, the filter unit 3 is used with a video projector. However, the present invention is not limited in such a manner and may be applied to air conditioning systems.

In addition to video projectors, such as LCD projectors, the air filter device may be applied to various air conditioning systems such as an air conditioner or a dust collector.

The present examples and embodiments are to be considered as illustrative and not restrictive, and the invention is not to be limited to the details given herein, but may be modified within the scope and equivalence of the appended claims.

1. An air filter device comprising:
a first air filter that captures dust from intake air and includes a rim, a filtering surface surrounded by the rim, and a grid dividing the filtering surface into a plurality of sections;
a base including an opening, through which air is drawn, and a frame, which surrounds the opening, wherein the first air filter is coupled to the frame at an upstream side of the opening;
a cleaner coupled to the base to move along and clean an upstream surface of the first air filter, wherein the cleaner includes a rotation brush that moves along the upstream surface of the first air filter while rotating to remove dust from the first air filter; and
a support that contacts and supports the rim and the grid at a downstream side of the first air filter against pressing forced applied to the first air filter by the rotation brush.

2. The air filter device according to claim 1, wherein
the first air filter further includes a filtering portion that captures dust, and
the rim, the grid, and the filtering portion of the first air filter are molded integrally with one another from a resin material.

3. The air filter device according to claim 1, wherein
the base further includes a base grid extending over the opening,
the base functions as the support, and
the frame of the base and the base grid of the base respectively support the rim of the first air filter and the grid of the first air filter.

4. The air filter device according to claim 3, wherein the base grid has a thickness that is generally the same as that of the frame of the base.

5. The air filter device according to claim 3, wherein the grid of the first air filter is grid-shaped and generally identical in size and shape with the base grid of the base.

6. The air filter device according to claim 3, further comprising a second air filter coupled to a downstream side of the base to capture particles of dust that are finer than those captured by the first air filter, wherein the frame of the base and the base grid serve to support the second air filter.

7. The air filter device according to claim 6, wherein
the base further includes a U-shaped retainer formed on the frame of the base,
the U-shaped retainer partially sandwiches a peripheral portion of the second air filter, and
part of the peripheral portion of the second air filter is elastically inserted into and supported by the U-shaped retainer.

8. The air filter device according to claim 1, further comprising a second air filter coupled between the base and the first air filter at the downstream side of the first air filter, wherein:
the second air filter includes a rim, a filtering surface surrounded by the rim, and a grid, which divides the filtering surface into a plurality of sections;
the second air filter functions as the support; and
the rim of the second air filter and the grid of the second air filter respectively support the rim of the first air filter and the grid of the first air filter.

9. The air filter according to claim 1, further comprising a motor that drives the rotation brush, wherein the first air filter, the base, the rotation brush, and the motor form a single unit that can be coupled in a removable manner to a product to which it is applied.

10. A video projector comprising:
an optical system; and
an air filter device arranged in an air inlet through which air is drawn to cool the optical system, wherein the air filter device includes:
a first air filter that captures dust from the drawn in air and includes a rim, a filtering surface surrounded by the rim, and a grid dividing the filtering surface into a plurality of sections;
a base including an opening, through which air is drawn, and a frame, which surrounds the opening, wherein the first air filter is coupled to the frame at an upstream side of the opening;
a cleaner coupled to the base to move along and clean an upstream surface of the first air filter, wherein the cleaner includes a rotation brush that moves along the upstream surface of the first air filter while rotating to remove dust from the first air filter; and
a support that contacts and supports the rim and the frame at a downstream side of the first air filter against pressing forced applied to the first air filter by the rotation brush.
